(19) United States
(12) Patent Application Publication
(10) Pub. No.: US 2026/0212178 A1
(43) Pub. Date: Jul. 23, 2026

(54) Machine Learning and Attention for Intelligent Sensing

(71) Applicant: The Regents of the University of California, Oakland, CA (US)

(72) Inventor: Mohsen Imani, Irvine, CA (US)

(21) Appl. No.: 19/141,286

(22) PCT Filed: Dec. 22, 2023
(86) PCT No.: PCT/US2023/085785

§ 371 Date: Jun. 19, 2025

Related U.S. Application Data
(60) Provisional application No. 63/435,264, filed on Dec. 25, 2022.

(51) Int. Cl. G06N 3/08; G06N 3/045; G06N 3/065

(52) U.S. Cl. CPC G06N 3/08; G06N 3/045; G06N 3/065

(57) ABSTRACT

Machine learning and attention for intelligent sensing in accordance with embodiments of the invention are disclosed. In one embodiment, a non-transitory computer readable storage medium is provided, the non-transitory computer readable storage medium storing a program comprising instructions that, when executed by at least one processor of a computing device, cause the at least one processor to perform operations including: perform a neural encoding phase by receiving analog sensor data from a sensing circuit connected to a sensor and encoding the analog sensor data into hypervectors; perform a hyperdimensional computing (“HDC”) learning phase using an HDC learning algorithm, wherein the HDC learning phase controls a sampling rate of an ADC connected to the sensing circuit; and perform an attention phase to control the sensing circuit to read out segments of the analog sensor data that include active data.

### CROSS REFERENCE TO RELATED APPLICATION

The current application claims priority to U.S. Provisional Patent Application No. 63/435,264 filed on Dec. 25, 2022, the disclosure of which is incorporated herein by reference.

### FIELD OF THE INVENTION

The present invention generally relates to sensors and more specifically to intelligent sensing systems.

### BACKGROUND

Sensors are devices that produces an output signal for the purpose of sensing a physical phenomenon. Typically, a sensor may detect events or changes in its environment. For example, an image sensor is a sensor that detects and conveys information used to make an image by converting the variable attenuation of light waves (as they pass through or reflect off objects) into signals. In another example, a radar may use radio waves to determine the distance, angle, and radial velocity of objects relative to the radar. In a further example a LiDAR may determine variable distance by targeting an object or a surface with a laser and measuring the time for the reflected light to return.

### SUMMARY OF THE INVENTION

The various embodiments of the present machine learning and attention for intelligent sensing (may be referred to as “intelligent sensing systems”) contain several features, no single one of which is solely responsible for their desirable attributes. Without limiting the scope of the present embodiments, their more prominent features will now be discussed below. In particular, the present systems, methods, and devices for intelligent sensing will be discussed in the context of hyperdimensional computing (HDC). However, the use of HDC is merely exemplary and various other computing methods may be utilized for intelligent sensing systems as appropriate to the requirements of a specific application in accordance with embodiments of the invention. After considering this discussion, and particularly after reading the section entitled “Detailed Description,” one will understand how the features of the present embodiments provide the advantages described here.

In a first aspect, a non-transitory computer readable storage medium is provided, the non-transitory computer readable storage medium storing a program comprising instructions that, when executed by at least one processor of a computing device, cause the at least one processor to perform operations including: perform a neural encoding phase by receiving analog sensor data from a sensing circuit connected to a sensor and encoding the analog sensor data into hypervectors; perform an HDC learning phase using an HDC learning algorithm, wherein the HDC learning phase controls a sampling rate of an ADC connected to the sensing circuit; and perform an attention phase to control the sensing circuit to read out segments of the analog sensor data that include active data.

In an embodiment of the first aspect, the hypervectors are holographic vectors in high-dimensional space.

In another embodiment of the first aspect, the hypervectors store information in their patterns and are learnable by the HDC learning algorithm.

In another embodiment of the first aspect, the HDC learning phase reduces the ADC sampling rate when the analog sensor data lacks active data.

In another embodiment of the first aspect, the active data includes data points that carry useful information.

In another embodiment of the first aspect, the attention phase is mathematically oriented and operates based on sensitivity of the analog sensor data during the neural encoding phase.

In another embodiment of the first aspect, the non-transitory computer readable storage medium is integrated on the sensor.

In a second aspect, a method for hyperdimensional learning for intelligent sensing is provided, the method comprising: performing a neural encoding phase by receiving analog sensor data from a sensing circuit connected to a sensor and encoding the analog sensor data into hypervectors; performing an HDC learning phase using an HDC learning algorithm, wherein the HDC learning phase controls a sampling rate of an ADC connected to the sensing circuit; and performing an attention phase to control the sensing circuit to read out segments of the analog sensor data that include active data.

In an embodiment of the second aspect, the hypervectors are holographic vectors in high-dimensional space.

In another embodiment of the second aspect, the hypervectors store information in their patterns and are learnable by the HDC learning algorithm.

In another embodiment of the second aspect, the HDC learning phase reduces the ADC sampling rate when the analog sensor data lacks active data.

In another embodiment of the second aspect, the active data includes data points that carry useful information.

In another embodiment of the second aspect, the attention phase is mathematically oriented and operates based on sensitivity of the analog sensor data during the neural encoding phase.

In another embodiment of the second aspect, the method is performed by a hyperdimensional learning module that is integrated on the sensor

In a third aspect, a computing device for hyperdimensional learning for intelligent sensing is provided, the computing device comprising: a processor; a memory storing a program comprising instructions that, when executed by the processor, cause the computing device to: perform a neural encoding phase by receiving analog sensor data from a sensing circuit connected to a sensor and encoding the analog sensor data into hypervectors; perform an HDC learning phase using an HDC learning algorithm, wherein the HDC learning phase controls a sampling rate of an ADC connected to the sensing circuit; and perform an attention phase to control the sensing circuit to read out segments of the analog sensor data that include active data.

In an embodiment of the third aspect, the hypervectors are holographic vectors in high-dimensional space.

In another embodiment of the third aspect, the hypervectors store information in their patterns and are learnable by the HDC learning algorithm.

In another embodiment of the third aspect, the HDC learning phase reduces the ADC sampling rate when the analog sensor data lacks active data.

In another embodiment of the third aspect, the active data includes data points that carry useful information.

In another embodiment of the third aspect, the attention phase is mathematically oriented and operates based on sensitivity of the analog sensor data during the neural encoding phase.

### BRIEF DESCRIPTION OF THE DRAWINGS

The various embodiments of the present intelligent sensing systems now will be discussed in detail with an emphasis on highlighting the advantageous features. These embodiments depict the novel and non-obvious intelligent sensing systems shown in the accompanying drawings, which are for illustrative purposes only. These drawings include the following figures:

FIG. 1 is a diagram illustrating a system for sensing devices with intelligent sensing in accordance with certain embodiments of the invention;

FIG. 2 is a block diagram illustrating a sensing device with intelligent sensing in accordance with certain embodiments of the invention;

FIG. 3 is a block diagram illustrating a server in accordance with certain embodiments of the invention;

FIG. 4 is a diagram illustrating an intelligent sensing system in accordance with certain embodiments of the invention;

FIG. 5 is a diagram illustrating lightweight learning in intelligent sensing systems in accordance with certain embodiments of the invention;

FIG. 6 is a diagram illustrating HDC encoding of raw sensor data in accordance with certain embodiments of the invention;

FIG. 7 is a diagram illustrating hyperdimensional learning features in accordance with certain embodiments of the invention;

FIG. 8 is a diagram illustrating a brain-inspired attention-based system for intelligent sampling in intelligent sensing in accordance with certain embodiments of the invention;

FIG. 9 is a diagram illustrating HDC encoding features in accordance with certain embodiments of the invention;

FIG. 10 is a diagram illustrating a comparison of HDC with deep neural network (DNN) in accordance with certain embodiments of the invention;

FIG. 11 is a diagram illustrating hyperdimensional learning for an attention mechanism and for HDC learning in accordance with certain embodiments of the invention; and

FIG. 12 is a diagram illustrating an intelligent sensing system using a LiDAR sensor in accordance with certain embodiments of the invention.

### DETAILED DESCRIPTION OF THE DRAWINGS

The following detailed description describes the present embodiments with reference to the drawings. These drawings, and their written descriptions, may indicate that certain components are formed integrally, and certain other components are formed as separate pieces. Those of ordinary skill in the art will appreciate that components shown and described herein as being formed integrally may in alternative embodiments be formed as separate pieces. Those of ordinary skill in the art will further appreciate that components shown and described herein as being formed as separate pieces may in alternative embodiments be formed integrally. Further, as used herein the term integral describes a single unitary piece.

While ubiquitous sensors are still rapidly growing in both sensor numbers and rate of data generation, the technology trajectories of existing approaches to sensor data processing cannot keep pace due to their limits in both algorithm and architecture. For example, Internet of Things (IoT) applications often analyze collected sensor data using machine learning algorithms. As the amount of data keeps increasing, many applications send the data to power systems (e.g., data centers) to run learning algorithms. In real IoT systems, the data generated by sensors often contain useless information for a large portion of the sensor activity. For example, machine learning algorithms continuously process visual sensors used for environmental/security monitoring to detect sensitive activities. However, these sensors only carry out useful information for a very small amount of time. The naive and highly dense data generation by today's sensors put a significant burden on both communication and machine learning systems.

Sensors may be part of various systems such as, but not limited to, a surveillance, objection detection, autonomous navigation, environment/securing monitoring, etc. Further, there may be various types of sensors. For example, sensors may include visual/image sensors such as, but not limited to, radar, camera, and LiDAR, that may be configured to capture data. However, the percentage of time that the sensors are producing data that is of interest is relatively short. For example, an airport may have security cameras to detect suspicious activity (e.g., weapons, theft, fights, etc.). Although the cameras are recording at all times, the percentage of time that the cameras generate useful data (may also be referred to herein as “active data”) is very small. In a surveillance system setting, active data capture may be less than 0.01%. In an object detection setting, active data capture may be less than 1%. In an autonomous sea navigation setting, active data capture may be less than 3%. In an environment monitoring setting, active data capture may be less than 0.005%. In systems that lack intelligence at the sensor level, resources are unnecessarily utilized as a large amount of data is generated and sent via a network to a backend for processing (e.g., for machine learning).

Typically, in conventional sensing and information processing, a sensing circuit reads raw sensor data (e.g., raw pixel/sensor values) produced by a sensor and generates an analog signal. Then, an analog-to-digital converter (“ADC”) converts the analog signal into the digital domain producing highly dense data based on the ADC maximum sampling rate. The generated data (e.g., the digital data) will be transferred through a network and processed by learning algorithms. In such examples, the learning modules are implemented on edge devices or in the cloud.

The present embodiments provide for situation-awareness for sensors (may also be referred to herein as “attention” or “attention mechanism”) that may enhance performance under various conditions. Further, control of the ADC sampling rate (e.g., reducing the rate of conversion) may also enhance performance under various conditions. For example, when an object is moving through a background. The system may want to ignore or reduce use of resources (e.g., capturing image data, reduce sampling rate, etc.) when the sensor captures only the background but increase use of resources when an object of interest is moving through the background. In addition, existing sensing and information processing systems are slow and ineffective as there may be 3-4 orders of magnitude gap between the sensors and the backend systems. For example, a sensor's sampling rate may be in the 100 MHz range whereas the backend AI may be running at a 10k sample/second range.

The present embodiments enable intelligent sensing using machine learning algorithms (may also be referred to as “lightweight machine learning algorithms”) that provide real-time feedback to the sensing circuit to ensure the sensor only generates data when required (e.g., when actively capturing useful information and/or when needed for learning purposes). In various embodiments, the sensors are equipped with an attention mechanism to generate data of interest and for learning purposes. For example, in the context of object detection, a machine learning module can be located near (or on) the sensor to ensure that the sensor generates data for possible frames/scenes that include objects, persons, or actions of interest.

To enable intelligent sensing, the lightweight machine learning algorithms need to be fast enough to provide real-time feedback to the sensing module. This feedback makes sensors aware of the target learning task; thus, sensors can generate selective and sparse data and potentially put attention on desired pixels/regions to enhance the quality of learning. In contrast, popular deep neural networks (DNN) consume a significant amount of memory and drain the battery life of devices during training and inference. Thus, it is difficult to deploy these models on or near the sensor. For example, the accelerated deep learning models for object detection, (i.e., Fast R-CNN) run 100 samples per second, while conventional visual sensors operate with hundreds of megahertz (MHz). This indicates 3-4 orders of magnitude gaps in performance between deep learning algorithms and the sensing modules. This gap can further increase, considering that the data generated by sensors need to be transferred through the network before a machine learning module can process it at the backend.

In addition, the challenge with existing deep learning models goes beyond performance and energy efficiency. For intelligent sensing, the learning model needs to operate over raw analog signals in order to control the sensing module (e.g., control the ADC sampling rate) before digitizing the data. However, the raw sensor data is an extremely noisy signal which cannot be learned by existing learning models. Further, the learning algorithms need to be memory-centric and area efficient so that it can be integrated into 3D with the sensor to ensure minimal area overhead and real-time sensor control.

The present embodiments address these limitations by providing sensing systems that can become intelligent for a wide range of sensing applications, including infrastructure, mobile devices, autonomous systems, robotic systems, to name a few. In many embodiments, the present intelligent sensing systems solve the analog data deluge problem by achieving multiple orders-of-magnitude data reduction in sensing systems through bio-inspired approaches.

The present embodiments, leverage brain-inspired HDC as an alternative computing method for processing in a robust and lightweight way. The use of HDC includes the realization that human brains compute with patterns of neural activity. Another realization includes that high-dimension vectors (i.e., hypervectors) may be utilized to represent neural activities. The use of hypervectors to represent neural activities has shown successful progress for many cognitive tasks such as activity recognition, object recognition, bio-signal classification, and signal processing. HDC offers an efficient learning strategy without over-complex computation steps such as, but not limited to, backpropagation in neural networks. In addition, it builds upon a well-defined set of operations with random HDC vectors, which makes the learning model extremely robust in the possible presence of hardware failures. Moreover, the simple operations in HDC can be readily implemented via various emerging computing architectures. Intelligent sensing systems in accordance with embodiments of the invention are further described below.

### Intelligent Sensing Systems

The present embodiments provide a hyperdimensional cognitive framework integrated with a sensing circuit to enable intelligent sensing. In certain embodiments, intelligent sensing systems include a neural encoding module, where the neural encoding module receives raw sensor data (e.g., analog sensor data) and converts the sensor data into holographic vectors in high-dimensional space. For example, HDC encoding may be coupled with a mixed-signal sensing module to ensure that hyperdimensional data transformation can be performed from analog sensor data. Further, intelligent sensing systems include a learning algorithm that makes decisions about the sampling rate of the ADC. The HDC learning aims to lower the ADC sampling rate for data points not carrying useful information.

Further, intelligent sensing systems combine the strength of learning representation with neural symbolic reasoning architecture. This integration is performed using knowledge distillation that leverages feature-based and relation-based knowledge to transfer model information from an already trained black-box deep learning model to a fully transparent neural-symbolic model.

Moreover, intelligent sensing systems include an attention mechanism that controls the sensing circuit to read out desired regions/frames. In many embodiments, such attention techniques are mathematically oriented and operate based on data sensitivity during the neural encoding phase. Features that may cause higher deviation in the high-dimensional representation may be selected as important regions/frames to be sent into a machine learning (teacher) model.

In addition, intelligent sensing systems include hardware acceleration that integrates algorithm and hardware to enable fast and real-time sensor control. For example, the present embodiments may be realized as an in-memory platform directly operating over raw analog sensor data and leveraging non-volatile memories as the base technology due to its CMOS compatibility, 3D integration capability, energy efficiency, and scalability. The present embodiments may provide orders of magnitude data reduction (e.g., four orders of magnitude data reduction) from sensors, thus enabling highly efficient learning and communication. In addition, the present embodiments may include an open-source algorithm-hardware library to provide orders of magnitude higher efficiency (e.g., at least three orders of magnitude higher efficiency), substantially higher robustness, advanced learnability, and reasoning compared to current state-of-the-art learning techniques.

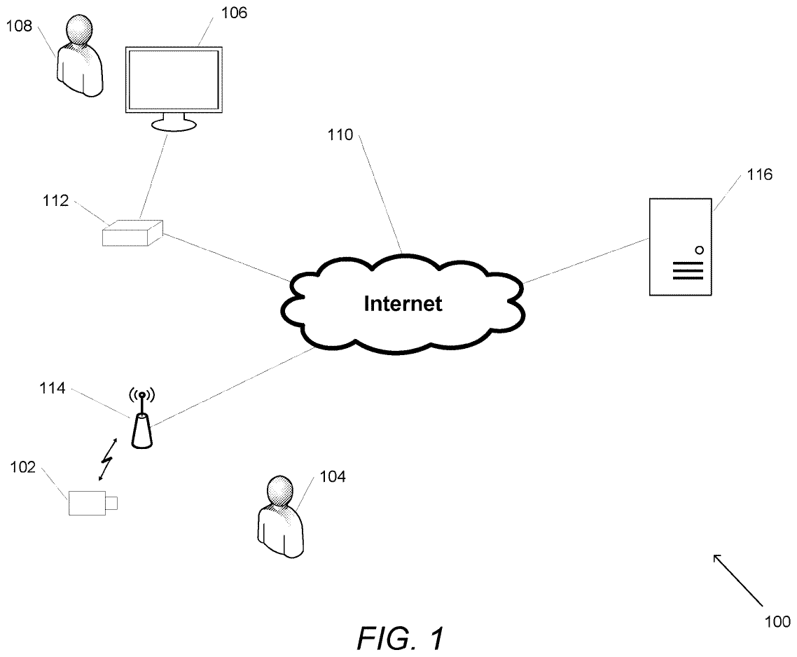

A block diagram illustrating a system for sensing devices in accordance with certain embodiments of the invention is shown in FIG. 1. A system 100 may include a sensing device 102 with intelligent sensing configured to capture data (e.g., raw sensor data such as, but not limited to, analog sensor data) as described herein. For example, the sensing device 102 may be a camera having a field of view configured to capture image data of a subject 104 (e.g., a person, object, etc.). In some embodiments, the sensing device 102 may include a user interface that for controls or may be controlled by a client device in network communication with the sensing device 102. In many embodiments, the system 100 may also include a client device 106. In some embodiments, the client device 106 may be utilized to allow a user 108 to monitor, implement, and/or update the various intelligent sensing processes as described herein. In several embodiments, the client device 106 may include various electronic devices, such as, but not limited to, a desktop computer, laptop computer, tablet computer, smartphone, etc.

In reference to FIG. 1, the client device 106 and the sensing device 102 may be connected to, and have access to, the Internet 110 in a manner known to one of ordinary skill in the art. For example, the client device 106 may access the Internet 110 using a variety of methods such as, but not limited to, a modem and/or router 112 (and/or a wireless access point). Further, the sensing device 102 may access the Internet 110 via a wireless access point 114, such as, but not limited to, Wi-Fi (and/or using a modem and/or router). In some embodiments, the sensing device(s) 102 and/or the client device 106 may access the Internet 110 using a cellular network. The system 100 may also include one or more servers 116 in communication with the sensing device 102 and/or the client device 106. In some embodiments, the sensing device 102 may be configured to transmit digital output data to the server 116 and/or the client device 106. In some embodiments, the digital output data may be utilized for and/or to generate edge learning data to further improve the intelligent sensing at the sensor 102, as further described below.

In further reference to FIG. 1, the sensing device 102 may be configured for intelligent sensing by utilizing lightweight learning at the sensing device 102, as further described below. For example, in many embodiments, intelligent sensing may be implemented at the sensing device 102 (i.e., integral to the device). In other embodiments, the intelligent sensing may be implemented utilizing a modular attachment that is either in direction connection or in network connection with the sensing device 102.

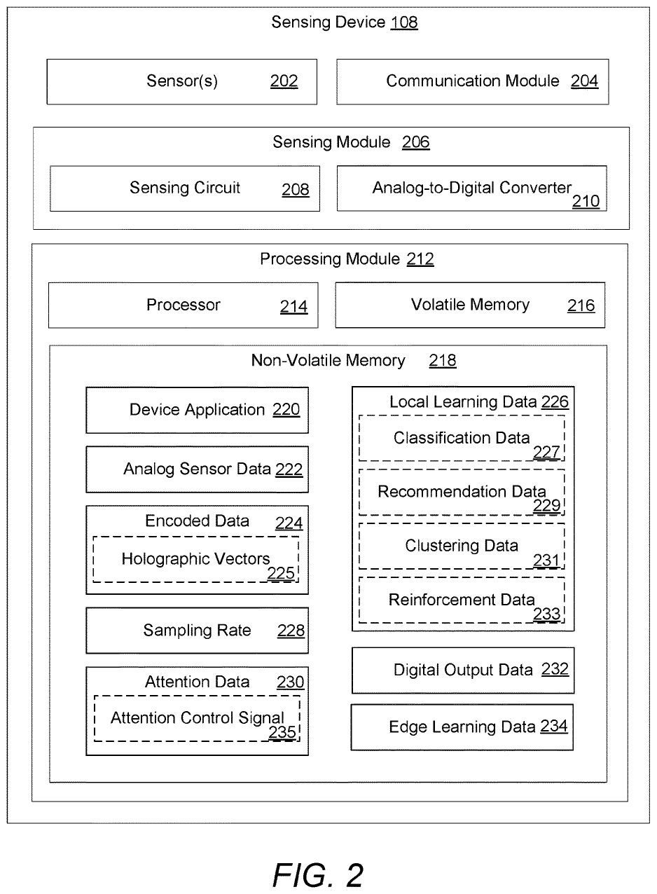

A block diagram illustrating a sensing device with intelligent sensing in accordance with certain embodiments of the invention is shown in FIG. 2. The sensing device 102 may include one or more sensor(s) 202 configured to capture analog sensor data 222 (may also be referred to as “sensor data” or “analog data”). In various embodiments, the sensing device 102 may be configured for sensing one or more physical measurements such as, but not limited to, an audio/video, light, pressure, temperature, weather, pressure, position, gas, etc. In some embodiments, the sensing device 102 may be configured to measure a single physical measurement. In some embodiments, the sensing device 102 may be configured to sense a plurality of physical measurements. Further, the sensing device 102 may include a communication module 204 for access to the Internet or for wireless communication with various devices, such as, but not limited to, a user device 106, a server 116, cloud devices, etc.

In reference to FIG. 2, the sensing device 102 may also include a sensing module 206 that may include a sensing circuit 208 and an ADC 210, as further described below. The sensing device 102 may also include a processing module 212 that may include a processor 214, a volatile memory 216, and a non-volatile memory 218. In various embodiments, the non-volatile memory 218 may include a device application 220 that configures the sensing device 102 to capture analog sensor data 222 and implement intelligent sensing, as further described herein. For example, the sensing device 102 may be configured to perform encoding processes (may also be referred to as a “encoding phase”) (e.g., neural encoding phase) on the analog sensor data 222 to generate encoded data 224 (e.g., holographic vectors 225, etc.). In many embodiments, the encoded data 224 may be utilized for local learning processes (may also be referred to as a “learning phase”) (e.g., HDC learning phase) utilizing local learning data 226 (e.g., binary classification data 227, recommendation data 229, clustering data 231, reinforcement data 233, etc.) and determining a sampling rate 228 for the ADC 210, as further described below. Further, the sensing device 102 may be configured to perform attention processes (may also be referred to as “attention phase”) utilizing attention data 230 and determining an attention control signal 235 for the sensing circuit 208, as further described below. In several embodiments, the intelligent sensing may allow the sensing device 102 to generate digital output data 232 (may also be referred to as “digital data) that may be sparse and selective, as further described below. In some embodiments, the digital output data 232 may be transmitted to an edge or cloud computing device (e.g., server 116) for analysis and the edge or cloud computing device may transmit, and the sensing device 102 may receive, edge learning data 234 for further implementation of intelligent sensing, as further described below.

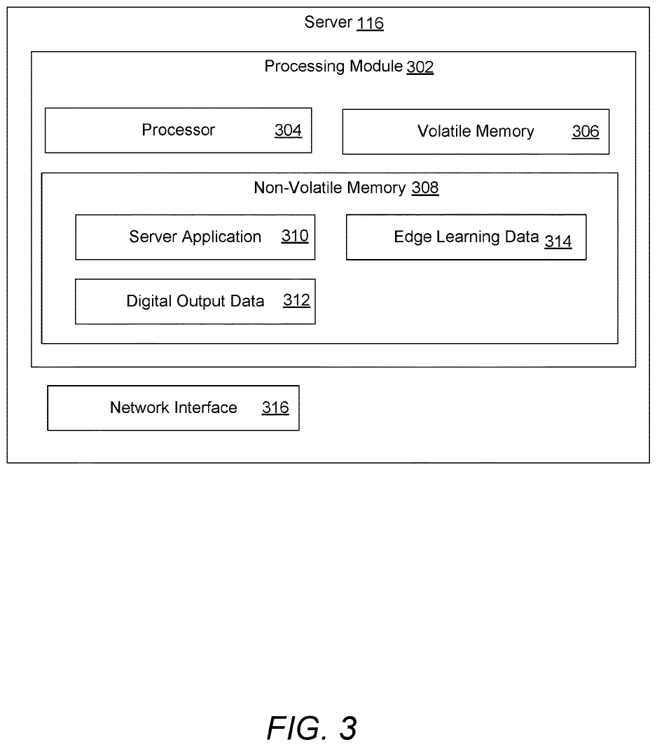

A block diagram illustrating a server in accordance with an embodiment of the invention is shown in FIG. 3. The server 116 may include a processing module 302 that may include a processor 304, a volatile memory 306, network interface 316, and a non-volatile memory 308. In many embodiments, the non-volatile memory 308 may include a server application 310 that configures the processor 304 to provide functionalities to the sensing device 102 and/or the client device 106, as further described herein. For example, the server 116 may be configured to receive digital output data 312 from the sensing device 102 using the network interface 316, as further described herein. In some embodiments, the server 116 may also be configured to perform machine learning algorithms using the digital output data 312 to generate edge learning data 314. For example, the server 116 may perform unsupervised machine learning using the digital output data 312 for insights, as further described herein. In various embodiments, the server 116 may be configured to transmit the edge learning data 314 to the sensing device 102 using the network interface 316, as further described herein.

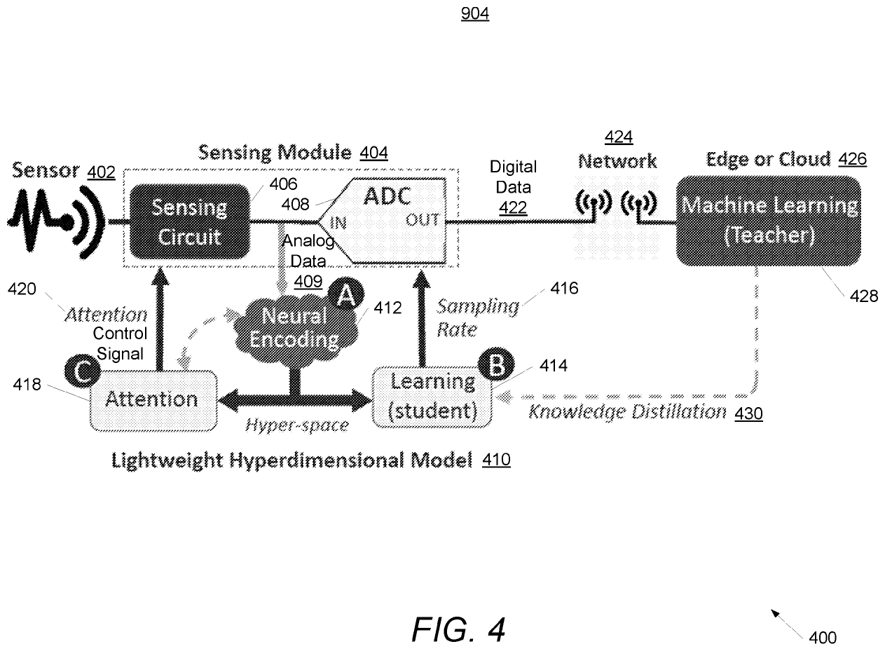

FIG. 4 is a diagram illustrating an intelligent sensing system in accordance with certain embodiments of the invention. The system 400 may include a sensor 402 that is operatively connected to a sensing module 404 that includes a sensing circuit 406 and an ADC 408. The diagram shows an overview of a framework exploiting HDC by a lightweight hyperdimensional model 410 for intelligent sensing by tightly integrating it with the sensing module 404. Generally, an ADC 408, which is responsible for transferring analog data into a digital domain, may be the most costly (in terms of power, energy, and latency) module of a sensor system. To ensure efficient and intelligent sensing, the HDC algorithms performed by the lightweight hyperdimensional model 410 need to control both the sensing circuit 406 and the ADC block 408. This indicates that the HDC algorithms should directly operate over raw analog sensor data captured by the sensor 402 and provide real-time feedback for (1) selective sampling via a sampling rate 416 to reduce the rate of data generated (e.g., digital data 422) from the sensor 402 and (2) attention via an attention control signal 420 to enhance the quality of learning.

In further reference to FIG. 4, the lightweight hyperdimensional model 410 may be configured to perform neural encoding by receiving raw analog data 409 and encoding the analog data 409 into holographic vectors in high-dimensional space. These hypervectors store information in their patterns and are learnable by the HDC algorithms. Further, the lightweight hyperdimensional model 410 may be configured to perform local learning 414 that makes decisions about the sampling rate 416 of ADC block 408. In various embodiments, the HDC learning 414 aims to lower the ADC sampling rate for data points that are not carrying useful information. For example, the sensing circuit 406 that nominally generates 60 samples/second would only generate 1 frame/second unless HDC detects that the incoming data points are carrying useful information. In addition, the lightweight hyperdimensional module 410 may be configured to perform attention-based processes 418 that can control the sensing circuit 406 using attention control signal(s) 420 to read out desired regions/frames. The attention-based processes 418 may be mathematically oriented and operate based on the sensitivity of data during the neural encoding phase 412. Features that may cause higher deviation in the high-dimensional representation may be selected as important regions/frames to be sent into the machine learning (teacher) model 428 running on an edge or cloud computing device 426 via the network 424. In some embodiments, the edge or cloud computing device 426 may transmit knowledge distillation 430 such as, but not limited to, edge learning data to further enhance the local learning processes 414.

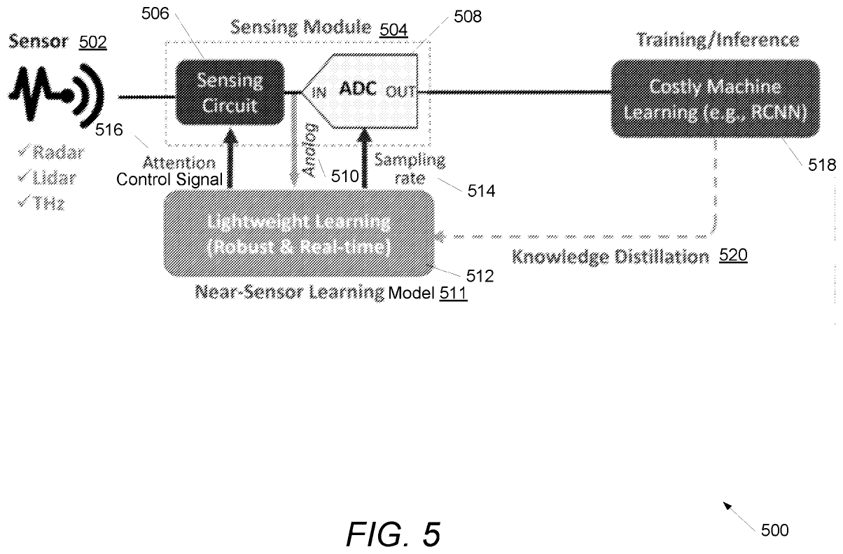

FIG. 5 is a diagram illustrating lightweight learning in intelligent sensing systems in accordance with certain embodiments of the invention. In various embodiments, an intelligent sensing system 500 may include so-called “lightweight” learning model (e.g., a near-sensor learning model 511) that receives analog data 510 from the sensor 502, performs lightweight learning processes 512 on the analog data 510, and provides feedback to the sensing circuit 506 and the ADC 508 of the sensing module 504. The feedback to the sensing circuit 506 may be via an attention control signal 516 that allows for attention-based sensing, as described above. The feedback to the ADC may be via a sampling rate 514 that allows for the ADC 508 to adjust the sampling rate. In many embodiments, sampling rate 514 allows the ADC 508 to decrease the sampling rate when the analog data 510 indicates that the sensor 502 is capturing data that is not of interest. When the analog data 510 indicates there is something of interest, then the system 500 may configure the sensor 502 to increase frequency to the nominal frequency. For example, if there is some object that is being detected in the background, then there may be some object of interest.

In many embodiments, the machine learning may be lightweight (e.g., utilizing a binary classification). In such embodiments, the lightweight learning may reduce complications. For example, in self-driving cars one or more cameras may be the sensors. In this example, the traditional machine learning 518 (at the backend) may have to specifically identify many types of objects (e.g., pedestrian, cars, bicycles, traffic lights, animals, etc.) and transmit knowledge distillation 520 to the near-sensor learning model 511. However, by having a binary classification where the system identifies whether or not one of the many types of objects is present (without identifying the type of object), the machine learning may be configured as a lightweight learning module (e.g., near-sensor learning model 512). In such embodiments, if the lightweight learning module “sees” an object of interest, the feedback loop may increase the frequency to a nominal frequency (e.g., generate sixty frame per second from image). However, if the system 500 detects that one of various objects are not available, it may reduce the frequency of ADC (e.g., one frame per second).

In some embodiments, the intelligent sensing systems may include a hyperdimensional encoding module that spreads raw analog sensor data over redundant high-dimensional vectors. In certain embodiments, novel dynamic encoding methods may cover various sensors, including but not limited to, cameras, LiDAR, and radars. The holographic representation preserves sufficient information even when substantial (up to 30%) hypervector elements are corrupted. The intelligent sensing system tightly couples HDC encoding with a mixed-signal sensing module to ensure that data transformation can perform as much as possible from analog sensor data with minimal feature extraction and costly digitization using ADC blocks.

In some embodiments, the intelligent sensing systems may include a near-sensor hyperdimensional learning that operates over high-dimensional neural representation to enable control of the sensor. To closely match the sensor data, such algorithms have the following properties: (1) ultra-fast to ensure real-time feedback to the sensing circuit, (2) efficient to enable near-sensor computing, and (3) human-interpretable to ensure generalization. In certain embodiments, the intelligent sensing systems include a dynamic, robust, and flexible neural computing model that mimics the brain from functional levels. Such methods fundamentally combine the strength of learning representation with neural symbolic reasoning architecture. This integration is performed using knowledge distillation that leverages both feature-based and relation-based knowledge to transfer model information from an already trained black-box deep learning to a fully transparent neural-symbolic model.

To further control the rate of data generated from sensors, intelligent sensing systems may utilize cognitive solutions related to attention. For example, the attention mechanism is an intelligent and self-supervised technique to select regions of interest in input data during the sensing process. In the context of liDAR and/or radar data, the attention mechanism selects which frames need to be sampled and areas that are more crucial for decision-making. The cognitive operations allow the intelligent sensing system to reason about and search through data that satisfy pre-specified constraints. This capability is powerful for understanding the relationship between sensor events in both time and space. The present embodiments exploit this feature to apply brain-like attention to the sensing circuit to adaptively adjust the sampling rate and identify regions of interest.

Although specific intelligent sensing systems are described above with respect to FIGS. 1-4, various intelligent sensing systems as appropriate to the requirements of a specific application can be utilized in accordance with embodiments of the invention. Near-sensor or on-sensor computing considerations in accordance with embodiments of the invention are further described below.

### Near-Sensor or On-Sensor Computing Considerations

Although the proposed algorithms are highly efficient, to ensure real-time feedback and ultra-low power sensing, tight integration between the algorithm and hardware and enabling in-memory computing may be utilized. Inspired by the human brain, the intelligent sensing system exploits HDC robustness to design near-sensor in-memory computing platforms that are highly approximate, parallel, and efficient. The in-memory platform directly operates over raw analog sensor data. The present embodiments may be built using a 3D integrated system as the hardware platform which incorporates the bottom tier of silicon CMOS for sensing and the top tiers for in-memory encoding and associative search. In certain embodiments, the intelligent sensing systems may leverage non-volatile memories as the base technology due to their excellent CMOS compatibility, 3D integration capability, superior energy efficiency, and great scalability.

In certain embodiments, machine learning may be performed on the sensor utilizing an in-memory build. The in-memory build may include a CMOS control, an oscillatory spiking neurons tier, an HDC encoding tier, and a content addressable memory tier. In various embodiments, the in-memory build allows the sensor to stay small. In some embodiments, the in-memory build is three-dimensional. In some embodiments, the in-memory build is two-dimensional but still relatively small. In addition, the in-memory build may execute various machine learning algorithms as appropriate to the specification application.

Intelligent sensing may generally include implanting techniques to make machine learning closer to the sensor. This enables sensor nodes, for example in an IoT system, to process data locally without transferring data to a third party or the cloud. There are several approaches that aim to enable edge or sensor intelligence. TinyML is an example of such effort in both algorithm and hardware. At the algorithm level, several techniques introduced neural network optimizations, such as sparsification and quantization, to enable lightweight learning near the sensor. In hardware, recent work used emerging hardware platforms to further accelerate machine learning algorithms to enable fast and efficient near-sensor intelligence. Despite the success, accelerated machine learning by algorithm-hardware co-optimization is still significantly costly to be integrated into the sensor. For example, the existing image classification and object detection solutions using ResNet-152 and YOLO ensure accurate prediction. However, such large networks would still be significantly costly to process on or even near the sensor. Even processing accelerating versions of deep networks on edge devices is often impossible, as training relies on costly gradient-based operations.

The present embodiments provide an updated “intelligent sensing” by giving sensors human-like intelligence to control their functionality depending on the target tasks. In many embodiments, it may be observed that the inefficiency of sensors comes from their static functionality, where the sensors naively generate a huge amount of data without being aware of the target tasks. In contrast, biological sensors, (e.g., human eyes or ears), are aware of the target and generate data only whenever necessary. Therefore, they generate orders of magnitude (e.g., five orders of magnitude) less amount of data as compared to existing sensing solutions. The present embodiments include an intelligent sensing framework that equips sensors with an ultra-lightweight brain-inspired model to make them capable of attention or controlling the sampling rate. As a result, the sensors will generate data only when the sensor contains useful information.

Sensors that detect a field of view are responsible for generating a stream of pixels representing the scenic event for a backend processor, which is analogous to the function of the eye-brain system. Systematic integration of computing and sensor arrays has been widely studied to eliminate off-chip data transmission and reduce ADC bandwidth, known as a processing near-sensor (PNS), combining sensor and processing element, and finally integrating pixels and computation unit, known as a processing-in-pixel (PIP). In contrast to the existing solutions, the present embodiments utilize near-sensor or in-sensor computing. Intelligent sensing systems include a framework that gives intelligence to the sensing modules to adaptively control when and how to generate data. The solution adds a lightweight brain-inspired model to the sensor. Importantly, such a learning model is not a part of the costly deep learning model that makes the final prediction. Instead, the brain-inspired model is a lightweight and self-supervised mechanism that: (1) significantly reduces the rate of data generated from the sensors when the information is not necessary for our target tasks, and (2) enables attention mechanism to enhance the quality of learning and give reasoning capability of the sensor. Thus, the sensors are capable of adapting to challenging scenarios.

Although specific 3D integration on a sensor is described above, various near-sensor or on-sensor integration as appropriate to the requirements of a specific application can be utilized in accordance with embodiments of the invention. Additional considerations of features of intelligent sensing systems in accordance with embodiments of the invention are further described below.

### Additional Considerations of Features of Intelligent Sensing Systems

As described above, existing sensing systems lack intelligence (e.g., machine learning insights) about the target that is being sensed and generate large-scale dense data that make both communication and learning significantly costly. For example, the data generated by sensors often contain useless information for a large portion of the sensor activity. To enable intelligent sensing, machine learning algorithms need to provide real-time feedback to a sensing circuit to ensure that the sensor only generates data when useful (e.g., when needed for learning purposes). The present intelligent sensing systems leverage HDC as an alternative computing method for robust and lightweight data processing. In many embodiments, a HDC-based framework directly operates on raw analog sensor data and provides real-time feedback to the sensor for (1) selective sampling to reduce the rate of data generated from the sensor and (2) attention to enhance the quality of learning.

Enabling real-time sensor data processing requires fundamental changes to rethink and redesign algorithms and architecture so that sensing systems can become intelligent, highly energy efficient, low latency, and reliable. The intelligent sensing systems may broadly impact every application space of the Internet-of-Things, including infrastructure, mobile devices, autonomous systems, robotic systems, medical and health systems, national security and defense, and energy management. HDC provides several advantages over existing sensing solutions. In a first key advantage, the present algorithms are capable of training in a one-shot, where object categories are learned from a few examples. This makes HDC capable of learning from the data stream on or near the sensors that often do not have an off-chip memory. The second key advantage is the HDC's natural robustness to extreme noise in sensing or underlying hardware, thus enabling the possibility of dealing with noisy sensor (analog) data and performing approximate in-memory computing. As described above, the present approach should provide orders of magnitude data reduction from sensors, thus enabling highly efficient learning and communication and also breaking the gap between today's sensors and biological systems. In addition, the open-source algorithm-hardware library should provide orders of magnitude higher efficiency, substantially higher robustness, advanced learnability, and reasoning compared to state-of-the-art ML-based techniques. Features of intelligent sensing systems are considered further below.

### Neural Encoding of Raw Analog Sensor Data

Much like how the human brain has millions of neurons and synapses that activate upon input stimuli, HDC uses hypervectors to represent any entities in high dimensional space, or hyperspace. Encoding, or transforming data into high-dimensional representation, is a step that leverages randomly generated hypervectors. In various embodiments, the hypervector is of a holistic representation, which distributes information equally over all its components. As discussed above, the encoding module of HDC should operate over the raw analog sensors data in order to be able to control the ADC block for intelligent sensing.

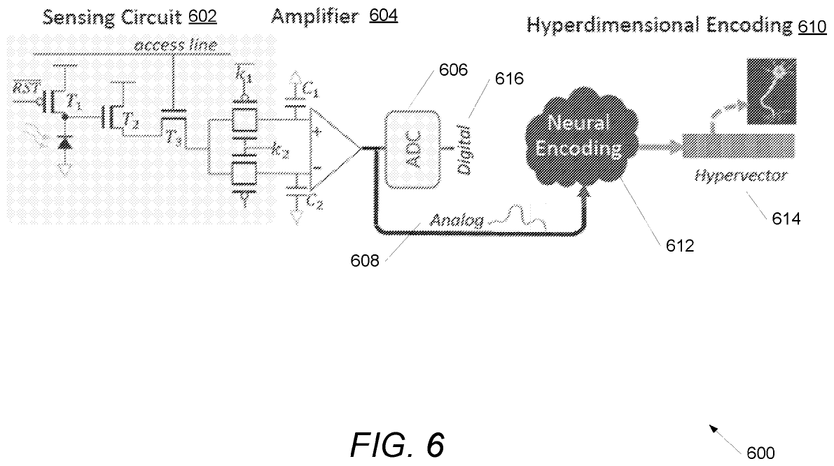

FIG. 6 is a diagram illustrating HDC encoding of raw sensor data in accordance with certain embodiments of the invention. The diagram 600 provides an example visual sensor (e.g., a camera) (not illustrated) that is operatively connected to a sensing circuit 602 to read out the pixel values and an ADC block 606 to translate the analog data into the digital domain 616. In some embodiments, an amplifier 604 may be connected to the sensing circuit 602 to amplify the analog data before being converted to digital data bay the ADC 606. The HDC encoding module 612 is responsible for receiving analog data 608 and representing it as a high-dimensional neural representation (e.g., hypervector 614) suitable for learning (may also be referred to as “hyperdimensional encoding” 610). The encoding hypervector 614 will be learned by the HDC algorithm and provide feedback to the ADC 606 to control the rate of data generation, as further described herein. This results in reducing the amount of data generated from the sensor, thus making communication/computation significantly efficient.

### Near-Sensor Hyperdimensional Learning

A goal of the present embodiments is to develop a lightweight and robust machine learning model that can enable intelligent sensing. Such models can be a classifier or regressor that controls the rate of data generated from the sensor by adjusting the sampling rate of the ADC.

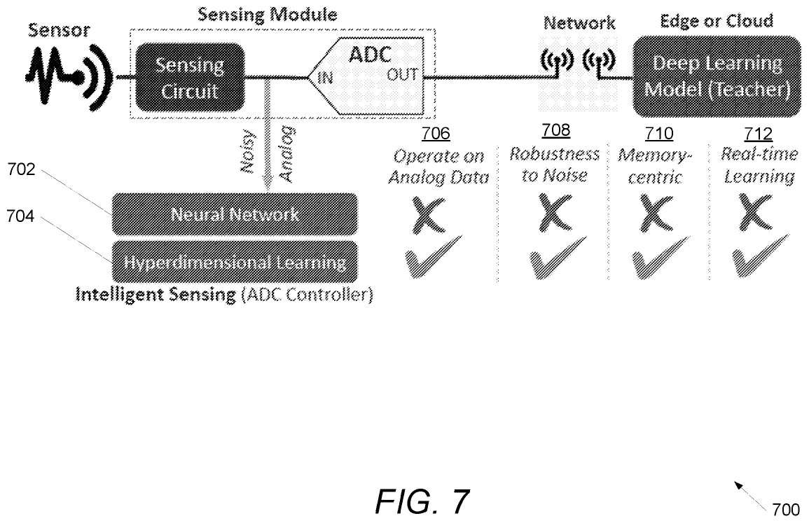

FIG. 7 is a diagram illustrating hyperdimensional learning features in accordance with certain embodiments of the invention. As illustrated in FIG. 7, in contrast to hyperdimensional learning 704, the existing learning models (e.g., neural networks 702) are unsuitable for intelligent sensing. A suitable machine learning model: (1) should operate 706 over raw analog signal, which is an extremely noisy signal, and be robust 708 to noise, (2) should provide ultra-fast prediction to ensure the model decision can be applied to our sensor immediately with no or minimal information loss, (3) should be memory-centric 710 and area efficient thus can be integrated with sensors while ensuring minimal area overhead. The present embodiments provide HDC models that are significantly robust and efficient and operate naturally based on the randomness of vectors in high-dimension. In addition, the present embodiments allow for real-time learning 712. These features make the HDC models nearly ideal for intelligent sensing.

The present embodiments provide for an ultra-lightweight, robust, and transparent hyperdimensional learning model that controls the rate of data generated from the sensor. A goal of such embodiments is to dynamically adjust the ADC sampling rate depending on the complexity of the data. The complexity is defined with respect to the deep learning (teacher) model, which is responsible for making the final prediction (e.g., the Fast R-CNN model used for object detection). In a real system, the majority of data generated by sensors does not carry useful information. The present HDC models detect data points containing information and accordingly increase the ADC sampling rate for those samples. This requires learning algorithms that are naturally robust to noise, are capable of operating over raw analog data, and can provide real-time feedback to the sensor.

### Attention-Based Cognitive Computing for Intelligent Sensing

The existing sensors are static and lack intelligence about the learning target. Therefore, they often operate poorly under challenging conditions. Intelligent sensing should rely on an ultra-fast, efficient, and transparent attention mechanism that can analyze the sensed signal and provide feedback to the sensing module. A goal of the attention mechanism is to enable dynamic feedback to ensure the sensor is aware of the target task and operating conditions.

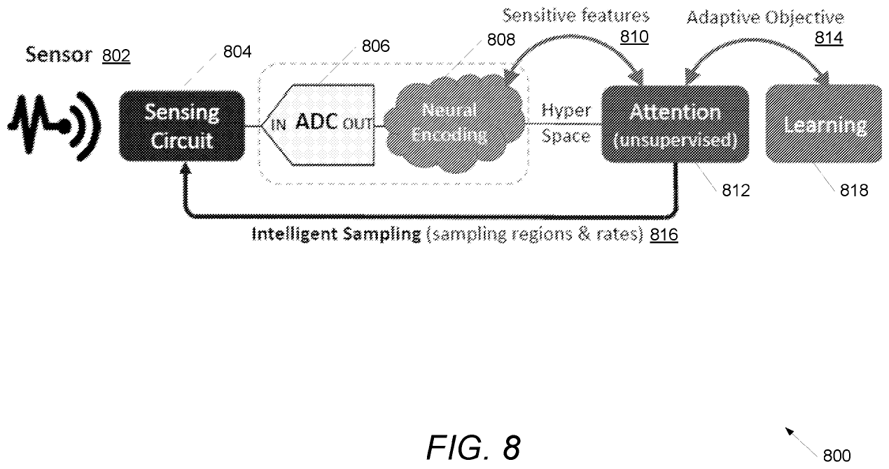

The present embodiments include an AI-empowered selective sensing approach using an unsupervised attention model to substantially screen out “informationless” data at the sensor front-end. FIG. 8 is a diagram illustrating a brain-inspired attention-based system for intelligent sampling 816 in intelligent sensing in accordance with certain embodiments of the invention. The system 800 may include as sensor 802 connected to a sensing circuit 804, as further described above. Further, the sensing circuit 804 may be connected to an ADC 806 that receives analog data and outputs digital data. In some embodiments, the ADC 806 may be connected to a lightweight learning model configured to perform neural encoding 808, attention (unsupervised) processes 812, and learning processes 818. In some embodiments, the attention processes 812 may share sensitive features 810 with the neural encoding processes 808. In some embodiments, the attention processes 812 may share adaptive objectives 814 with the learning processes 818.

In reference to FIG. 8, the attention mechanism 812 adaptively detects regions of interest and suitable sampling rates using transparent and efficient HDC mathematics. The attention algorithms may be co-designed with a hardware platform to be suited for learning on edge devices with limited memory and resources. As described above, the robust and holistic representation from HDC encoding maintains the integrity of the data, allowing it to be symbolized. The semantic space of the hypervectors, defined by the space in which there is a well-defined semantic meaning to the hypervector representation, is further extended by HDC's cognitive operators. In addition, bundling creates hypervectors representing a subset of its operands, binding creates association (composition), and permutation creates sequences. Therefore, the present embodiments provide a transparent manipulation of the symbolic data over the hyperspace. Overall, this feature opens up new opportunities for using the described models for intelligent sensing applications, as it enables backtracking of the algorithm with transparent operations backed by interpretable encoding. The present embodiments exploit this interpretability to apply self-attention to important/sensitive features 810.

### HDC Encoding

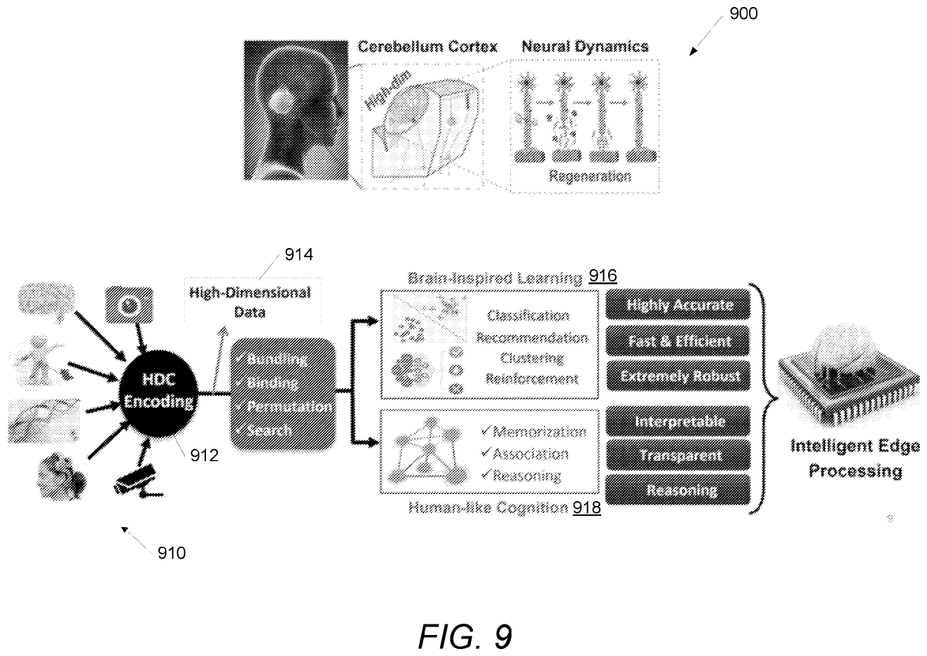

FIG. 9 is a diagram illustrating HDC encoding features in accordance with certain embodiments of the invention. In certain embodiments, the HDC encoding 912 maps analog data from one or more sensors 910 to high dimensional space (e.g., high-dimensional data 914) and then computations are performed. As illustrated in diagram 900, by way of analogy, HDC encoding can be thought of as looking at an object, where that information maps in the brain as high dimensional neural activity (i.e., you see the object). However, at the neuron level, they are millions of neurons that are in action to process seeing that object. In this example, the brain does computation based on vectors and maps the neuron data to high dimensional space so that you perceive the object. HDC encoding performs in a similar method, where it takes the voluminous analog data from the sensor and maps it to a high dimensional space using hyper-vectors. Then, the intelligent sensing system can perform lightweight machine learning over the encoded data. For example, the system may perform brain-inspired learning 916 such as, but not limited to, classification, recommendation, clustering, reinforcement, etc. The system may also perform human-like cognition 918 such as, but not limited to, memorization, association, reasoning, etc.

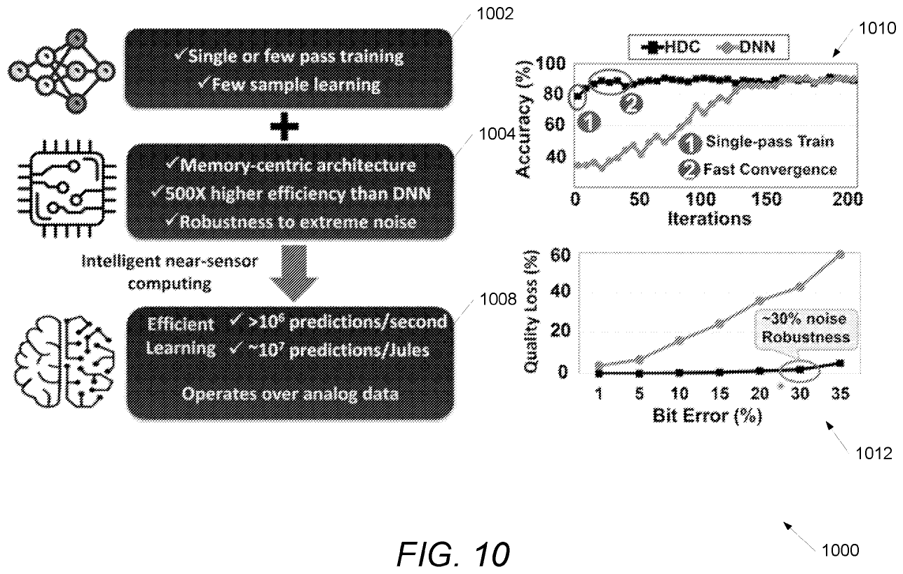

FIG. 10 is a diagram illustrating a comparison of HDC with deep neural network (DNN) in accordance with certain embodiments of the invention. Overall, HDC is more robust and efficient than existing machine learning (e.g., deep learning models). For example, HDC provides for faster computation than DNN. In particular, HDC allows for single or few pass training and few sample learning 1002. In addition, HDC may be implemented using a memory-centric architecture 1004 with a significant higher efficiency 1008 than DNN. Further, HDC has robustness to extreme noise and can operate over analog data. A graph 1010 illustrating accuracy as a function of iterations for HDC vs DNN is provided. As illustrated in graph 1010, HDC allows for single-pass training and fast convergence compared to DNN. Further, a graph 1012 illustrating quality loss (%) as a function of bit error (%) for HDC vs DNN is provided. As illustrated in graph 1012, HDC provides approximately 30% noise robustness compared to DNN.

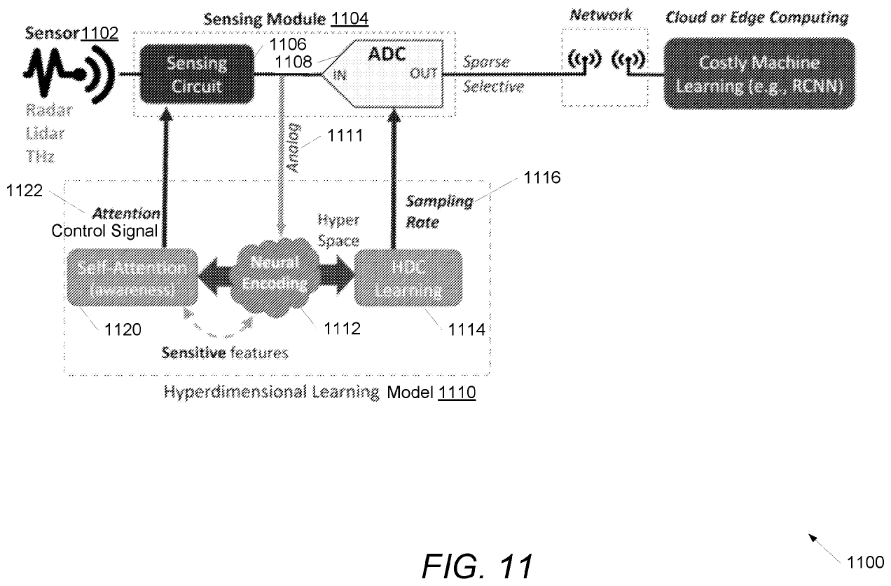

FIG. 11 is a diagram illustrating hyperdimensional learning for an attention mechanism and for HDC learning in accordance with certain embodiments of the invention. As described above, one or more sensor(s) 1102 may be connected to a sensing module 1104 having a sensing circuit 1106 and an ADC 1108. In many embodiments, a lightweight machine learning may be hyperdimensional learning model 1110 that is configured to perform neural encoding 1112, HDC learning 114, and self-attention 1120. In various embodiments, the neural encoding 1112 may receive analog sensor data 1111 and map it to high dimensional space (i.e., hyperspace) using hypervectors. Then, the hyperdimensional learning model 1110 may perform a HDC learning phase 1114 to control the sampling rate 1116 of the ADC, as further described above. In addition, the hyperdimensional learning model 1110 may also perform a self-attention awareness process to control the sensing circuit 1106 using an attention control signal 1122, as further described above.

Although specific considerations of features of intelligent sensing systems are described above with respect to FIGS. 6-11, a variety of features of intelligent sensing systems may be considered and optimized as appropriate to the requirements of a specific application can be utilized in accordance with embodiments of the invention. Experiment and evaluation of intelligent sensing systems in accordance with embodiments of the invention are further described below.

### Experiment and Evaluation Of Intelligent Sensing Systems

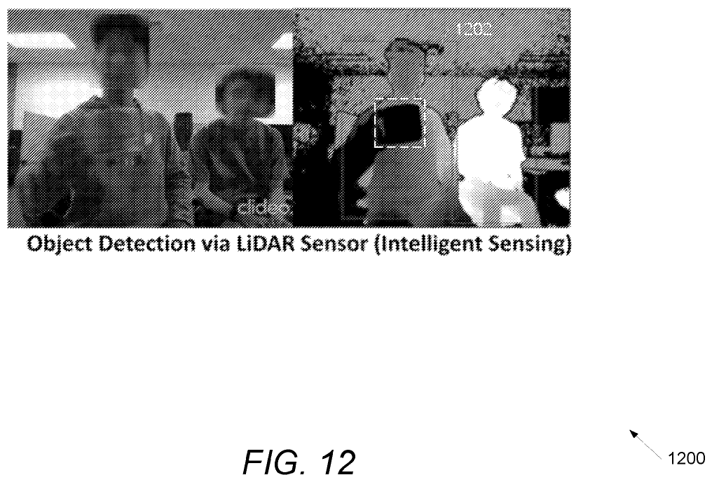

FIG. 12 is a diagram illustrating an intelligent sensing system using a LiDAR sensor in accordance with certain embodiments of the invention. The intelligent sensing system 1200 was configured to perform object detection on a cup 1202 using a LiDAR sensor. Specifically, the sensor was placed in a room and when there is no activity (i.e., the sensor does not detect the cup), the system did not generate data (or generated significantly less data). For example, the intelligent sensing system is able to differentiate between when people are in the office but a cup is not detected (and thus the system does not generate data). Thus, for the vast majority of time, the sensor is operating at a reduced capacity (via the attention mechanism) and the ADC sampling rate was reduced (via the HDC learning). Object detection by the LiDAR sensor using intelligent sensing produced 99.4% lower data generation than a baseline sensor during activity recognition in an indoor office setting. In addition, the intelligent sensing system showed significant energy improvement compared to a baseline RCNN object detection and lower amount of RCNN activation/computation, where HDC cost was minimal. When the attention mechanism is utilized, the accuracy and efficiency should show further improvements. As described above, the attention mechanism provides self-attention on important targets and allows for context-aware prediction. Thus, the intelligent sensing system allows for adaption to challenging environments and sensing conditions.

Although a specific experiment and evaluation of an intelligent sensing system is discussed above with respect to FIG. 12, any of a variety of experiments and evaluations for intelligent sensing systems as appropriate to the requirements of a specific application can be utilized in accordance with embodiments of the invention. While the above description contains many specific embodiments of the invention, these should not be construed as limitations on the scope of the invention, but rather as an example of one embodiment thereof. It is therefore to be understood that the present invention may be practiced otherwise than specifically described, without departing from the scope and spirit of the present invention. Thus, embodiments of the present invention should be considered in all respects as illustrative and not restrictive.

What is claimed is:

1. A non-transitory computer readable storage medium storing a program comprising instructions that, when executed by at least one processor of a computing device, cause the at least one processor to perform operations including:
perform a neural encoding phase by receiving analog sensor data from a sensing circuit connected to a sensor and encoding the analog sensor data into hypervectors;
perform a hyperdimensional computing (“HDC”) learning phase using an HDC learning algorithm, wherein the HDC learning phase controls a sampling rate of an ADC connected to the sensing circuit; and
perform an attention phase to control the sensing circuit to read out segments of the analog sensor data that include active data.

2. The non-transitory computer readable storage medium of claim 1, wherein the hypervectors are holographic vectors in high-dimensional space.

3. The non-transitory computer readable storage medium of claim 2, wherein the hypervectors store information in their patterns and are learnable by the HDC learning algorithm.

4. The non-transitory computer readable storage medium of claim 1, wherein the HDC learning phase reduces the ADC sampling rate when the analog sensor data lacks active data.

5. The non-transitory computer readable storage medium of claim 4, wherein the active data includes data points that carry useful information.

6. The non-transitory computer readable storage medium of claim 1, wherein the attention phase is mathematically oriented and operates based on sensitivity of the analog sensor data during the neural encoding phase.

7. The non-transitory computer readable storage medium of claim 1, wherein the non-transitory computer readable storage medium is integrated on the sensor.

8. A method for hyperdimensional learning for intelligent sensing, the method comprising:
performing a neural encoding phase by receiving analog sensor data from a sensing circuit connected to a sensor and encoding the analog sensor data into hypervectors;
performing a hyperdimensional computing (“HDC”) learning phase using an HDC learning algorithm, wherein the HDC learning phase controls a sampling rate of an ADC connected to the sensing circuit; and
performing an attention phase to control the sensing circuit to read out segments of the analog sensor data that include active data.

9. The method of claim 8, wherein the hypervectors are holographic vectors in high-dimensional space.

10. The method of claim 9, wherein the hypervectors store information in their patterns and are learnable by the HDC learning algorithm.

11. The method of claim 8, wherein the HDC learning phase reduces the ADC sampling rate when the analog sensor data lacks active data.

12. The method of claim 11, wherein the active data includes data points that carry useful information.

13. The method of claim 8, wherein the attention phase is mathematically oriented and operates based on sensitivity of the analog sensor data during the neural encoding phase.

14. The method of claim 8, wherein the method is performed by a hyperdimensional learning module that is integrated on the sensor.

15. A computing device for hyperdimensional learning for intelligent sensing, the computing device comprising:
a processor;
a memory storing a program comprising instructions that, when executed by the processor, cause the computing device to:
perform a neural encoding phase by receiving analog sensor data from a sensing cir cuit connected to a sensor and encoding the analog sensor data into hypervectors;
perform a hyperdimensional computing (“HDC”) learning phase using an HDC learning algorithm, wherein the HDC learning phase controls a sampling rate of an ADC connected to the sensing circuit; and
perform an attention phase to control the sensing circuit to read out segments of the analog sensor data that include active data.

16. The computing device of claim 15, wherein the hypervectors are holographic vectors in high-dimensional space.

17. The computing device of claim 16, wherein the hypervectors store information in their patterns and are learnable by the HDC learning algorithm.

18. The computing device of claim 15, wherein the HDC learning phase reduces the ADC sampling rate when the analog sensor data lacks active data.

19. The computing device of claim 18, wherein the active data includes data points that carry useful information.

20. The computing device of claim 15, wherein the attention phase is mathematically oriented and operates based on sensitivity of the analog sensor data during the neural encoding phase.
